(19) United States
(12) Patent Application Publication
(10) Pub. No.: US 2021/0133829 A1
(43) Pub. Date: May 6, 2021

(54) REPUTATION ANALYSIS BASED ON CITATION GRAPH

(71) Applicant: Daniel L. Coffing, Fairfax, VA (US)

(72) Inventor: Daniel L. Coffing, Fairfax, VA (US)

(21) Appl. No.: 17/069,572

(22) Filed: Oct. 13, 2020

Related U.S. Application Data
(60) Provisional application No. 62/914,449, filed on Oct. 12, 2019.

(51) Int. Cl. G06Q 30/02; H04L 9/06

(52) U.S. Cl. CPC G06Q 30/0282; H04L 2209/38; H04L 9/0618

(57) ABSTRACT

A reputation system can be configured to access a plurality of content items produced by a content source, wherein the plurality of content items are stored on one or more content management systems, calculate a set of content scores for the plurality of content items, and generate an aggregated score based on the set of content scores. The reputation system may further identify a citation map for source materials used by the content source and calculate a aggregated source score based on the citation map. The reputation system may further generate a comprehensive reputation score for the content source based on the aggregated score and the aggregated source score and provide the comprehensive reputation score for display to a user.

### CROSS-REFERENCE TO RELATED APPLICATIONS

The present patent applications claims the priority benefit of U.S. provisional patent application 62/914,449 filed Oct. 12, 2019, the disclosure of which is incorporated by reference herein.

### BACKGROUND OF THE INVENTION

### 1. Field of the Invention

The present invention relates to digital content analysis and the dissemination of cogent digital discourse.

### 2. Description of the Related Art

The amount of information on the Internet grows at an unprecedented pace with little verification of the veracity of such information. The verification of the veracity of content sources on the Internet requires analysis of massive amount of information and human input as to determine whether the information is false or misleading. There is currently an unavailability of a way to quickly evaluate the reputation in quantitative terms of the probable veracity of the content items and the content source. There is, therefore, a need in the art for improved system and methods for determining the reliability of a content source that disseminates content items.

### SUMMARY OF THE CLAIMED INVENTION

System and methods for quantification of reputation of content source are disclosed. The method includes accessing content items produced by a content source that are stored in one or more content management systems. The method also includes calculating a set of content scores for the plurality of content items and generating an aggregated score based on the content scores of the content items. The method further includes identifying a citation map for source materials used by the content source and calculating an aggregated source score based on the citation map. The method further includes generating a comprehensive reputation score for the content source based on the aggregated score and the aggregated source score and providing the comprehensive reputation score for display to a user.

In another embodiment, a system includes a content management system that is configured to store content items produced by the various content sources. The content management system is further configured to communicate via one or more networks with a reputation system and users. The system further includes the reputation system that calculates a set of content scores for the plurality of content items, generates an aggregated score based on the set of content scores, identifies a citation map for source materials used by the content source, calculates an aggregated source score based on the citation map, generates a comprehensive reputation score for the content source based on the aggregated score and the aggregated source score, and provides the comprehensive reputation score for display to a user.

A third claimed embodiment involves a non-transitory computer readable storage medium. Said medium stores instructions that may be executed by a processing device to perform a method that includes accessing content items produced by a content source that are stored in one or more content management systems. The method also includes calculating a set of content scores for the plurality of content items and generating an aggregated score based on the content scores of the content items. The method further includes identifying a citation map for source materials used by the content source and calculating an aggregated source score based on the citation map. The method further includes generating a comprehensive reputation score for the content source based on the aggregated score and the aggregated source score and providing the comprehensive reputation score for display to a user.

### BRIEF DESCRIPTION OF THE DRAWINGS

FIG. 1 illustrates an exemplary network environment for implementing aspects of the present technology;

FIG. 2 is a diagram providing a visual illustration of an example calculation of a comprehensive reputation score, in accordance with various aspects of the subject technology;

FIG. 3 shows an example method 300 for providing a comprehensive reputation score, in accordance with various embodiments of the subject technology; and

FIG. 4 is a system diagram of an example computing system that may implement various systems and methods discussed herein in accordance with various embodiments of the subject technology.

### DETAILED DESCRIPTION

Aspects of the present disclosure involve systems and methods for generating a comprehensive reputation score for a content source. A content source may be, for example, a person, an organization, a media outlet, a platform, or any other identifiable source that shares or otherwise disseminates one or more content items. A content item may include an argument, a speech, a presentation, a forum entry, an article, a blog post, a publication, a video, or other piece of content.

The comprehensive reputation score may be provided to other users to consider when consuming a content item shared by the content source. For example, if the computation reputation score for a content source indicates that the content source is reliable or generally publishes cogent and truthful content of high quality, a user may be inclined to share, cite, or consume content from that source. If, on the other hand, the computation reputation score for a content source indicates that the content source is unreliable or of poor quality, a user may avoid use and/or consumption of content from that source. Additionally, by providing a comprehensive reputation score for a content source, the content sources themselves may be motivated to improve the content items that are shared, cited, or otherwise published in order to improve their reputation score.

According to some embodiments, the comprehensive reputation score for a content source may be calculated based on an aggregated content score and an aggregated source score. The aggregated content score may be calculated based on analysis of all of the content produced by the content source. In some embodiments, a content score may be calculated for each content item and aggregated into the aggregated content score for the content source. Each content item may be analyzed based on veracity, authenticity, argumentative strength, spelling, grammar, or other factors related to the quality of the content item.

The aggregated source score may be calculated based on analysis of all the sources of material that the content source uses. For example, a content source may share, repost, advertise, recommend, or comment on a content item produced by another content source. Additionally, the content source may cite a content item produced by another content source. A aggregated source score may be calculated based on a reputation score for other content sources that are used or referenced by the content source and/or content scores for content items that are used or referenced by the content source.

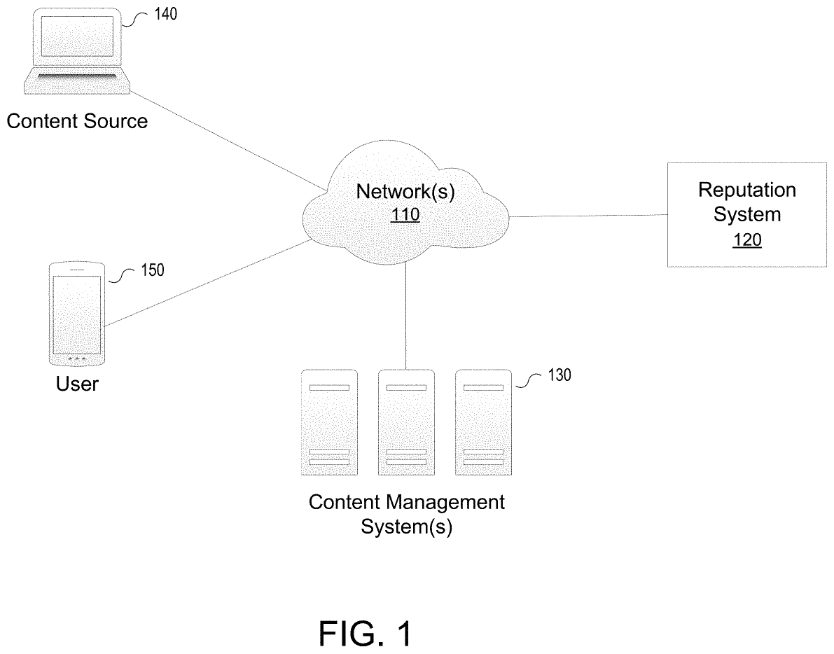

FIG. 1 illustrates an example network environment for implementing aspects of the present technology. Although FIG. 1 illustrates a client-server network environment, other embodiments of the subject technology may include other configurations including, for example, peer-to-peer environments or single-system environments. Furthermore, one of ordinary skill in the art will understand that, for the network environment and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

The network environment illustrated in FIG. 1 may include a reputation system 120, one or more content management system 130, at least one content source 140, and one or more users 150. The reputation system 120, content management system(s) 130, source(s) 140, and users 150 may be configured to communicate via one or more networks 110 (e.g., the internet, a local area network, a wireless area network, or a combination of different networks). The content management systems 130 may be configured to store content items produced by the various content sources 140 and/or provide access to the content items to users 150. A content item may include an argument, a speech, a presentation, a forum entry, an article, a blog post, a publication, a video, or other piece of digital content that can be stored on computer readable media. Although FIG. 1 shows reputation system 120 as separate from the one or more content management systems 130, in some embodiments, the reputation system 120 may be a part of one or more of the content management systems 130.

Various aspects of the subject technology relate to a reputation system 120 configured to calculate and assign a comprehensive reputation score for a content source 140 and provide the comprehensive reputation score to users 150 for consumption. A content source may be, for example, a person, an organization, a media outlet, a platform, or any other identifiable source that shares or otherwise disseminates one or more content items. For example, the content source may be an opinionator, pundit, author, publisher, or other source.

According to some embodiments, the comprehensive reputation score may be provided to users 150 via a display. For example, the comprehensive reputation score may be included in a profile page for the content source or as a badge on content items produced by the content source. Furthermore, the comprehensive reputation score for a content source may be used for other purposes as well. For example, the may comprehensive reputation score be used to rank the content source or content items associated with the content source, surface search results, prioritize placement of advertisements, select rewards, or the like.

The reputation system 120 may be configured to retrieve, from the content management systems 130, content items produced by the content source and analyze the content items to rate or score the content items. Based on the scores or rating of each content item associated with the content source, the reputation system 120 may calculate and assign a top-level cogency ratings or aggregated content score to the content source. The aggregated content score may be in the form of a drillable aggregate representation the content source's level of cogency, persuasiveness, good truth-citizenship (e.g., contains statements that are valid or not intended to deceive), or other desired quality. Additional measures of quality may include factors such as use or avoidance of argumentative tricks and shortfalls such as ad hominems, non-sequiturs, equivocations, topic shifts/distractions, side-stepped rebuttals, and the like. In essence providing a convenient measure for other users to identify the reputation of the content source and motivate the content source to publish content items of quality. In this way, the state of public discourse may be improved.

The reputation system 120 may further be configured to take into consideration of the primary source material used by a content source (e.g., an author, speaker, or publisher) using a similar scrutiny for quality (e.g., cogency, persuasiveness, veracity, or other measure of quality) against some aggregate of the those primary source's public material. The primary source material may be, for example, references cited, shared, redistributed, or commented on in a content item associated with the content source. This next level analysis may be performed recursively so as to rate the cogency reputation of the secondary parties in part by assessing the cogency of their primary sources, etc. Further levels of analysis may similarly be performed.

According to some embodiments, the reputation system 120 takes into account the reputation cascade or credibility transference going on in a citation mapping between sources and citations. For example, content source X may cite content source Y, and content source Y may cite a reputable news outlet. Content source Y may increase its reputation score by a great amount by citing the reputable news outlet while content source X may increase its reputation score by a lesser amount by citing content source Y. Dependencies such as these based on reasoning quality may be quantified and taken into consideration when calculating a reputation score for a content item.

In other embodiments, if a content source misquotes or misuses a content item or other content source, the reputation system may take the misuse of source material and decrease the reputation score for the content source. Various artificial intelligence and/or machine learning techniques may be used herein to determine whether a content source misquotes or misuses another source. Accordingly, having the reputation score published may serve as a damping force against trolls and the spreading of fake news as there starts to be a penalty for passing along bad rhetoric from bad sources.

In additional embodiments, the reputation system expands the concept of what it means to use and/or cite source material (e.g., an explicit reference like a hyperlink or footnote). Detecting use of source material may also include watching for matches or at least strong similarities in the material so that linkages and reputation dependencies can be flagged.

Various systems can provide processes related to certification or content verification and may be performed by a central service or as a distributed workload (e.g., a “mining” operation, etc.) performed in whole or part by users and other participant (e.g., blockchain nodes, etc.). For example, a source monitoring system can guard against changes to cited evidence. Alerts and notifications can be generated based on changes to a source material. In some examples, thresholds can be set for alerts and notifications based on a significance or depth of change treatment to a source.

In one example, where evidence is classified as, for example, subjective or phenomenological, increased or decreased weight may be given to certain features of the evidence. Video components may be of increased value due to increased reliability of facial identity and kinematics, voice print analysis may be utilized and/or emphasized, and other treatments.

A news falsification (e.g., a “fake news” detection) system can use heuristics and content exploration to identify fake news and/or revoke certification of evidence. Novelty, style, common appeal, network relationships, and other direct and indirect features of the evidence may be used as heuristics for identifying false news and/or references.

A plagiarism detection process can certify content as original or as properly attributed. The plagiarism detection process can identify directly copied content (e.g., verbatim copying) as well as intentionally (or unintentionally) obfuscated plagiarized content based on premises, arguments, interrelationships, and the like. The above evidence certification systems and processes can be implemented as validation workloads performed by a centralized system or, in the case of a distributed system (discussed below), performed on an opt-in basis.

Evidence and/or users may be credentialed so that time and/or reputation of a user are linked to support or use of particular references. In some examples, a blockchain-based system can be used to provide an immutable record of evidence interactions and, additionally, allow for a user history to be tracked from the evidence interactions. A blockchain-based system can provide, for example and without imputing limitation, (1) immutability and decentralization, (2) distributed and opt-in workloads (e.g., “mining” operations, etc.), (3) trustless interactions (in other words, trust among participants is intrinsic to the closed system and a priori knowledge of users between users is unnecessary to support transactions/interactions), (4) tokenization of activities (e.g., interactions such as support or dispute of evidence is recorded on the blockchain in a discrete manner), (5) encryption layers for distributing content elements, (6) smart contract operations for providing features such as time-lagged trust and post hoc auditability based on smart contract terms, etc., and (7) comprehensive reputation scores or evidence classifications that are weighted differently by both invariable factors (e.g., absolute truth of a claim) and variable factors (e.g., affective or rhetorical appropriateness for circumstances) for differently clustered sets and subsets of human social networks. Credentials of a reference may depend upon which users have indicated support for the reference along with what other references (e.g., credibility, certification, etc.) each respective supporting user has also supported. The credential blockchains may additionally be available to downstream processes for analyzing references, users, or both.

In some examples, users can explore the data store through an interactive browser or user portal. For example, and without imputing limitation, a user may explore evidence by filtering on various filter parameters (e.g., source, relevance, validity certification, persuasiveness, other abstractions related to evidence). In some cases, the user can select from the explored evidence to “deploy” it or otherwise interact or use it for dialogue or review purposes (e.g., as part of a publication, etc.). Further, relevant content may be fed to users based on analysis of user arguments (e.g., entered through an interface) run against certified evidence in the data store. Additionally, users may perform “mining” or otherwise complete workloads in order to build reputation or a credit of some sort. In some examples, a mining operation may include providing compute for validating evidence by processing layer 2 attributes of evidence on the blockchain (e.g., voice or facial recognition, type classification, kinematic analysis, etc.) or layer 3 attributes such as performing a natural language processing as described in Application No. 62/645,114, entitled “System and Method for Processing Natural Language Arguments and Propositions,” hereby incorporated by reference in its entirety. In some examples, a mining operation may include other forms of content verification, including manual verification, and may require user access rights based on whether the user is an institution, reputation of the user, user history, and the like. For example, and without imputing limitation, a user may flag an image showing signs of tampering, indicate a failure to replicate a result of an experiment, dispute a “deep-fake” video or the like based on firsthand knowledge or with supporting evidence (e.g., located elsewhere on the blockchain, etc.). Through a user portal, users can apply various filters to review content related to selected subjects (e.g., entertainment, rhetorical, vetted, etc.). Various pieces of argument solution evidence can be cross-referenced so that argument can navigate between argument solution evidence related by, for example, shared factual bases, sources, participants, and the like.

Users may also review and/or comment on evidence. As discussed above, comments may be linked to user reputation via an immutable comment record for each user and/or an immutable record of user comments for each evidence item. In order to foster high quality user interaction, the user portal may include screening tests, training materials and tracking, points for good behavior, and the like.

According to some embodiments, the reputation system enables premise neutralization such that emotionally-flattened premises or propositions in one piece of content under scrutiny is similar to a flattened premise element elsewhere in the system or other sources that has already been assessed. Aspects of the subject technology may treat particular premises as modular elements in the fact-base—useful for building or destroying arguments. A content source's tabulated reputation score may also be affected by their use or citation of highly vetted or highly undercut premises from the fact-base within the system.

For example, argumentation in a content source may include premises or propositions, chain of reasoning, logical elements, sub-propositions, and proponent motivations, which may be implicitly or explicitly included in a party's statements. A mapping of an argument in a content source may be generated such that a stack of premises or propositions underlying a stated premises or proposition can be revealed.

Arguments may be mapped using ontologies related to various domains in order to efficiently tag arguments, organize propositions, determine rules related to the relationship between propositions, and determine rules for resolving arguments. The domains can include generalized “problem spaces” (e.g., abstracted concepts related to groupings of problem types), professional specialties, syntactical elements, reasoning or logic elements, and the like. Each ontology may include a hierarchical definition of entities and/or objects and their relationships within the particular domain space. Ontologies can be probabilistically determined, defined by a rules-based process, or a mix of the two.

For example, and without imputing limitation, words from a natural language content may be mapped along a multi-dimensional vector, as well as based on a coordinate value within a particular semantic space. Each dimension or axis can then be related to a particular abstraction (such as ownership, occupation, field of work, etc.), which may be used to place the mapped word or words into a mapped space. Clustering, distance between words, topographies, topologies, and the like can be used to identify particular groupings and to identify a word or words as related to particular concepts. In other examples, ontologies can be defined using specified rules, such as keyword or word grouping identification. If a particular word or sequence of words is observed (e.g., via string matching and the like), the word, sequence of words, segment of text, or natural language content in which they were identified can be tagged according to a predetermined mapping.

The ontologies may further be used to define relationships between propositions and arguments, so that the arguments and relationships may be placed within an idea and/or argument map (“IAM”). The IAM can be used to further process the natural language content, provide a visualization of the flow of ideas and/or arguments contained within the natural language content, or perform simulations of various hypothetical responses or expansions of the contained ideas or arguments. In some examples, a user may define concepts and relations for mapping. The user may then be presented with suggestions for further concept and relation definitions (e.g., based on a model informed by historical selections, the user, and/or a global history). Further, the informed model may be updated in response to the how the user utilizes the suggestions.

An argument analysis tool can further use the IAM to provide insights based on the mapped propositions and/or sentences using one or more rules. Demonstrative arguments may be analyzed to identify and verify explicit propositions, as well as implicit or necessary sub-propositions that may support or invalidate the explicit propositions of the analyzed argument. Analysis may be provided by a first-order logic engine that examines the truth of propositions or may be performed by a higher-order or non-classical logic engine that processes and analyzes the relationships between propositions and relationships between relationships (e.g., interdependency between two particular propositions may be reliant upon another interdependency between two other propositions) or following some other formalized abstract argument framework such as that of Dung or some extension or intermediate formal system such as ASPIC+. In some examples, graph-based analysis may identify various characteristics of an argument (e.g., circular reasoning as indicated by cycles and the like). In other examples, Bayesian and/or Markov-based probabilistic analysis may place argument components, and complete arguments along a spectrum of likelihood based on identified probabilities of explicit and implicit propositions.

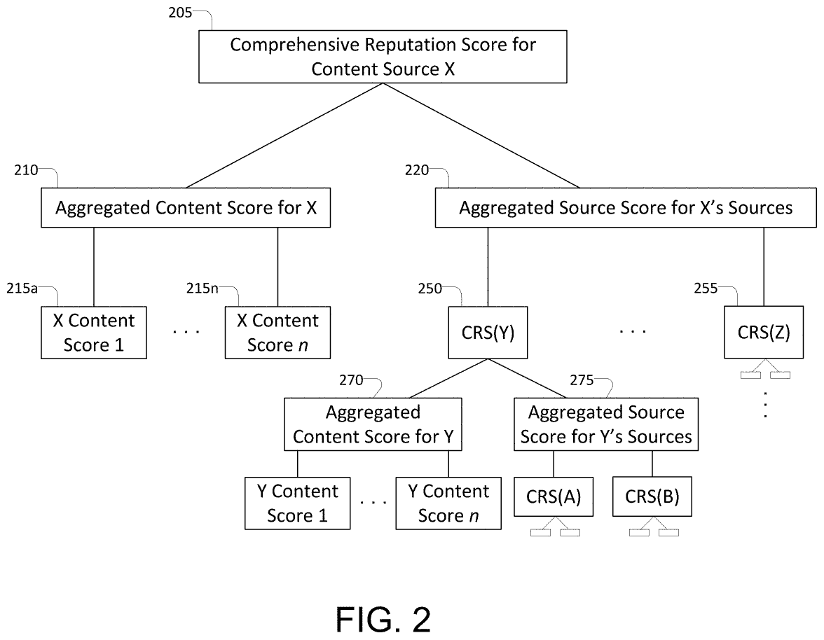

FIG. 2 is a diagram providing a visual illustration of an example calculation of a comprehensive reputation score, in accordance with various aspects of the subject technology. The comprehensive reputation score may be calculated in many different ways, with different formulas, weights, technologies, and processes. FIG. 2 helps to illustrate the general concept and how some embodiments may approach the generation of the comprehensive reputation score. In FIG. 2, the comprehensive reputation score for content source X 205 may be generated by a reputation system based on an aggregated content score 210 for content source X and a aggregated source score 220 for content source X.

The aggregated content score 210 may be calculated based on analysis of all of the content produced by the content source X. In some embodiments, content scores 215a-215n may be calculated for all or a subset of content items produced by the content source X. Each content item may be analyzed based on veracity, authenticity, argumentative strength, spelling, grammar, or other factors related to the quality of the content item. In some cases, the content scores 215a-215n may be weighted during the process of generating the aggregated content score based on factors such as recency, popularity (e.g., number of views, hits, searches, cites, etc.), length, type (e.g., blog post, article, video presentation, etc.), or other factor.

The aggregated source score 220 for content source X may be calculated based on analysis of all the sources of material that the content source uses which may include content items produced by other content sources or the other content sources themselves (e.g., content source Y or content source Z). A aggregated source score 220 may be calculated based on a reputation score 250 and/or 255 for other content sources that are used or referenced by the content source and/or content scores for content items that are used or referenced by content source X. Furthermore, these scores may also be weighted based on factors such as recency, popularity (e.g., number of views, hits, searches, cites, etc.), length, type (e.g., blog post, article, video presentation, etc.), or other factor.

In the example scenario illustrated in FIG. 2, content source X may share, repost, advertise, recommend, or comment on a content item produced by content source Y. Additionally, content source X may cite a content item produced by content source Z. The aggregated source score 220 for content source X may be calculated based on a source score (e.g., the content score) for the source materials used or cited by content source X. These source scores for the content item produced by content source Y and/or content item produced by content source Z may be included in source scores and used to generate the aggregated source score 220 for content source X.

Additionally, the aggregated source score 220 for content source X may be calculated based on reputation scores for primary sources that content source X cites or otherwise uses. In the example scenario illustrated in FIG. 2, since content source X used content source Y and content source Z as sources, the aggregated source score for content source X may be calculated based on the comprehensive reputation score 250 for content source Y and the comprehensive reputation score 255 for content source Z. Furthermore, similar processes to generate the comprehensive reputation score 250 for content source Y and the comprehensive reputation score 255 for content source Z as were performed to generate the comprehensive reputation score 205 for content source X. Accordingly, in some embodiments, the comprehensive reputation scores may be calculated recursively, iteratively, and/or may be updated over time.

FIG. 2 helps to illustrate the recursive nature of the analysis using the example of content source Y. As noted above, the aggregated source score for content source X may be calculated based on the comprehensive reputation score 250 for content source Y. The comprehensive reputation score 250 for content source Y is calculated based on the aggregated content score for content source Y 270 and the aggregated source score for content source Y 275. The aggregated content score for content source Y 270 may be calculated based on analysis of all of the content produced by the content source Y. The aggregated source score 275 for content source Y may be calculated based on analysis of all the sources of material that the content source uses which may include content items produced by other content sources or the other content sources themselves (e.g., content source A or content source B). A aggregated source score 275 may be calculated based on a reputation score for other content sources that are used or referenced by the content source and/or content scores for content items that are used or referenced by content source Y.

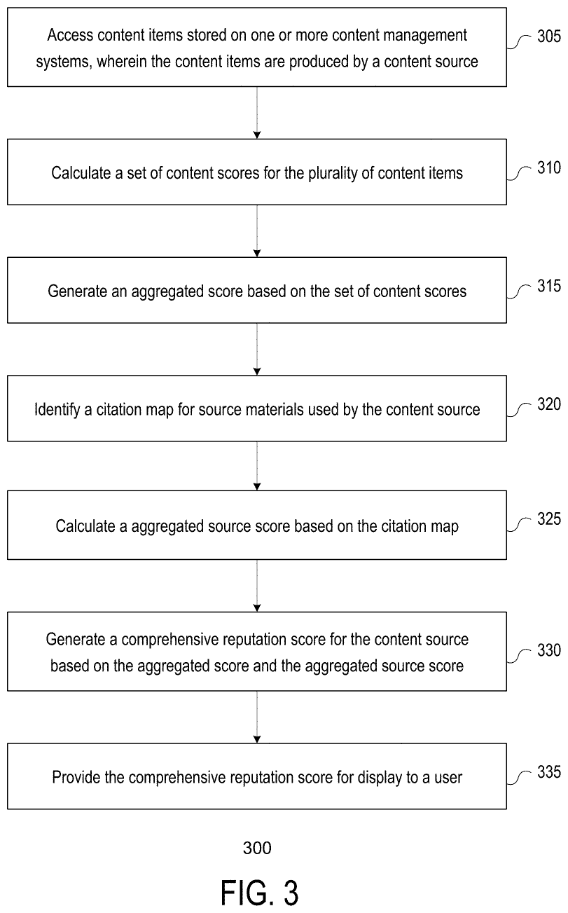

FIG. 3 shows an example method 300 for providing a comprehensive reputation score, in accordance with various embodiments of the subject technology. Although the methods and processes described herein may be shown with certain steps and operations in a particular order, additional, fewer, or alternative steps and operations performed in similar or alternative orders, or in parallel, are within the scope of various embodiments unless otherwise stated. Method 300 may be implemented by a system which may be embodied as, for example, one or more servers associated with a reputation system.

At operation 305, the reputation system may access content items produced by a content source. These content items may be stored on one or more content management systems and may include, for example, an argument, a speech, a presentation, a forum entry, an article, a blog post, a publication, a video, or other piece of content. The reputation system may calculate content scores for each of the content items at operation 310 and generate an aggregated score based on the set of content scores at operation 315.

At operation 320, the reputation system may identify a citation map for source materials used by the content source. The citation map may be generated by processing one or more of the content items produced by the content source and identifying uses or source material and mapping the source material and/or sources of the source material. The reputation may calculate an aggregated source score based on the citation map at operation 325.

At operation 330, the reputation system may generate a comprehensive reputation score for the content source based on the aggregated score and the aggregated source score and providing the comprehensive reputation score for display to a user at operation 335.

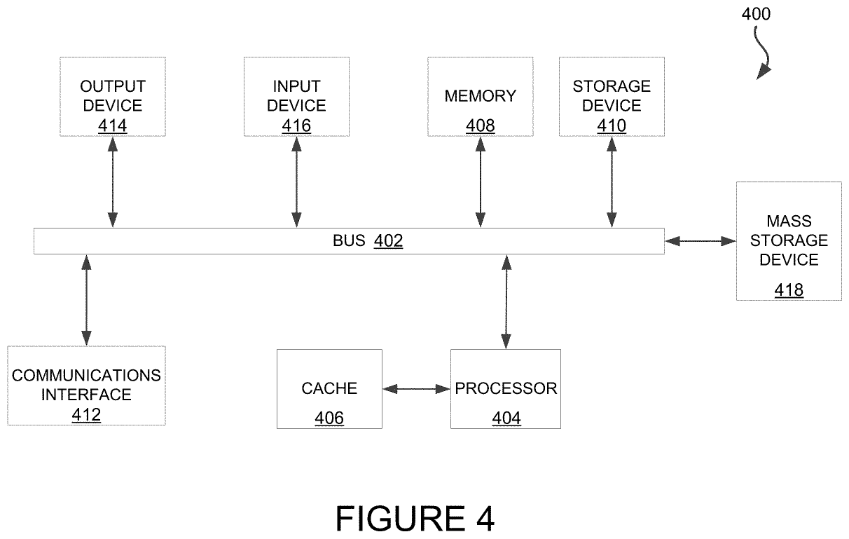

FIG. 4 is a system diagram of an example computing system that may implement various systems and methods discussed herein in accordance with various embodiments of the subject technology. The computer system 400 includes one or more computing components in communication via a bus 402. In one implementation, the computing system 400 includes one or more processors 404. The processor 404 can include one or more internal levels of cache 406 and a bus controller or bus interface unit to direct interaction with the bus 402. The processor 404 may specifically implement the various methods discussed herein. Main memory 408 may include one or more memory cards and a control circuit (not depicted), or other forms of removable memory, and may store various software applications including computer executable instructions, that when run on the processor 404, implement the methods and systems set out herein. Other forms of memory, such as a storage device 410 and a mass storage device 418, may also be included and accessible, by the processor (or processors) 404 via the bus 402. The storage device 410 and mass storage device 418 can each contain any or all of the methods and systems discussed herein.

The computer system 400 can further include a communications interface 412 by way of which the computer system 400 can connect to networks and receive data useful in executing the methods and system set out herein as well as transmitting information to other devices. The computer system 400 can also include an input device 420 by which information is input. Input device 416 can be a scanner, keyboard, and/or other input devices as will be apparent to a person of ordinary skill in the art. An output device 414 can be a monitor, speaker, and/or other output devices as will be apparent to a person of ordinary skill in the art.

The system set forth in FIG. 4 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions.

The description above includes example systems, methods, techniques, instruction sequences, and/or computer program products that embody techniques of the present disclosure. However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for reputation analysis, the method comprising:
accessing a plurality of content items produced by a content source, wherein the plurality of content items are stored on one or more content management systems;
calculating a set of content scores for the plurality of content items;
generating an aggregated score based on the set of content scores;
identifying a citation map for source materials used by the content source;
calculating an aggregated source score based on the citation map;
generating a comprehensive reputation score for the content source based on the aggregated score and the aggregated source score; and
providing the comprehensive reputation score for display on a display screen.

2. The method of claim 1, wherein the plurality of content items include at least one of an argument, a speech, a presentation, a forum entry, an article, a blog post, a publication, or a video.

3. The method of claim 1, wherein the content source includes at least one of an organization, a person, a media outlet, or a platform.

4. The method of claim 1, wherein calculating the set of content scores includes identifying the source materials cited in the content items.

5. The method of claim 1, wherein calculating the set of content scores include determining that the content items includes misquotes or misuses.

6. The method of claim 1, wherein calculating the set of content scores include assigning a weight to one or more features of evidence in the content items.

7. The method of claim 1, wherein calculating the set of content scores include mapping an argument in the content item.

8. The method of claim 7, wherein mapping the argument includes using ontology to determine a relationship between prepositions and arguments, and to determine rules for resolving the argument.

9. The method of claim 1, further comprising allowing user interaction regarding the content item via a user portal.

10. The method of claim 1, wherein calculating the set of content scores includes detecting changes to the source materials cited by the content items, wherein the changes are tracked using blockchain-based system to provide an immutable record of evidence of the user interaction.

11. A system for reputation analysis, the system comprising:
memory that maintains a plurality of content items produced by a content source, wherein the plurality of content items are stored on one or more content management systems;
a processor that executes instructions stored in memory, wherein the processor executes the instructions to:
calculate a set of content scores for the plurality of content items;
generate an aggregated score based on the set of content scores;
identify a citation map for source materials used by the content source;
calculate an aggregated source score based on the citation map; and
generate a comprehensive reputation score for the content source based on the aggregated score and the aggregated source score; and
a display screen that displays the comprehensive reputation score.

12. The system of claim 11, wherein the plurality of content items include at least one of an argument, a speech, a presentation, a forum entry, an article, a blog post, a publication, or a video.

13. The system of claim 11, wherein the content source includes at least one of an organization, a person, a media outlet, or a platform.

14. The system of claim 11, wherein the processor calculates the set of content scores by identifying the source materials cited in the content items.

15. The system of claim 11, wherein the processor calculates the set of content scores by determining that the content items includes misquotes or misuses.

16. The system of claim 11, wherein the processor calculates the set of content scores by assigning a weight to one or more features of evidence in the content items.

17. The system of claim 11, wherein the processor calculates the set of content scores by mapping an argument in the content item.

18. The system of claim 17, wherein the processor maps the argument by using ontology to determine a relationship between prepositions and arguments, and to determine rules for resolving the argument.

19. The system of claim 11, further comprising a user portal that allows user interaction regarding the content item.

20. The system of claim 11, wherein the processor calculates the content scores by detecting changes to the source materials cited by the content items, wherein the changes are tracked using blockchain-based system to provide an immutable record of evidence of the user interaction.

21. A non-transitory, computer-readable storage medium, having embodied thereon a program executable by a processor to perform a method for reputation analysis, the method comprising:
accessing a plurality of content items produced by a content source, wherein the plurality of content items are stored on one or more content management systems;
calculating a set of content scores for the plurality of content items;
generating an aggregated score based on the set of content scores;
identifying a citation map for source materials used by the content source;
calculating an aggregated source score based on the citation map;
generating a comprehensive reputation score for the content source based on the aggregated score and the aggregated source score; and
providing the comprehensive reputation score for display.
